(19) United States
(12) Patent Application Publication
(10) Pub. No.: US 2008/0309464 A1
(43) Pub. Date: Dec. 18, 2008

(54) Registering system, registering device, registering method, and registering program of ID originating device installation position information

(75) Inventor: Shinpei Chihara, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 12/155,650

(22) Filed: Jun. 6, 2008

(30) Foreign Application Priority Data
Jun. 13, 2007 (JP) JP2007-156300

(51) Int. Cl. H04Q 5/22

(52) U.S. Cl. 340/10.42

(57) ABSTRACT

An object of the present invention is to provide an ID originating device installation position managing system that enables registration of installation position information to be supported also in a system having no network between an ID originating device and a managing system. For this, when a worker installs an ID originating device 100 or confirms an operation of the ID originating device 100, he/her employs a worker terminal 200 capable of receiving ID information being transmitted from the ID originating device 100, and yet of performing a registering operation, thereby making it possible to register installation position information in its site.

### INCORPORATION BY REFERENCE

This application is based upon and claims the benefit of priority from Japanese patent application No. 2007-156300, filed on Jun. 13, 2007, the disclosure of which is incorporated herein in its entirety by reference.

### RELATED ART

The present invention relates to a registering system of ID originating device installation position information, a registering device of ID originating device installation position information, a registering method of ID originating device installation position information, and a registering program of ID originating device installation position information, and more particularly to a registering system of ID originating device installation position information, a registering device of ID originating device installation position information, a registering method of ID originating device installation position information, and a registering program of ID originating device installation position information that allow a work of registering the installation position information of the ID originating device into a database to be supported, by detecting ID information that an ID originating device originates at the moment of registering the installation position information of the ID originating device into the database, and selecting a position on a floor plan displayed on a monitor screen of a terminal with a mouse operation etc.

Conventionally, the positioning system has been studied that enables a current position of a mobile terminal to be acquired, by installing a large number of the ID originating devices, each of which has ID information for identifying itself, and yet transmits this ID information to a certain scope with infra-red communication, RF-ID, Bluetooth (Registered Trademark), or the like, in a space, and searching a database into which installation position information of each ID originating device has been registered based upon ID information received from the ID originating device by the mobile terminal such as a portable telephone. Such a positioning system necessitates a work of not only pre-installing a large number of the ID originating devices in a space, but also for pre-registering coordinate information on a map into the database as installation position information of each ID originating device. In this registering work, the larger the number of the ID originating devices being installed becomes, the heavier a burden upon a worker becomes.

One example of the system for, at the moment of installing various appliances in a space, supporting a work that is done at the time of registering its installation position information into a database is described in Patent document 1. The system described in the Patent document 1 is a system for supporting a work that is done at the time of registering installation position information of home network appliances into a database, in which when an unregistered home network appliance is detected over a home network, an icon indicative of the home appliance is displayed in a screen of a management PC etc. In this system, a worker moves a home appliance icon to a location identical to the location, in which the home appliance has been actually installed, on a floor plan displayed in the identical screen with a drag and drop operation of a PC mouse, thereby allowing the registration of installation position information of the home network appliance into the database to be completed.

Further, one example of the sign managing system for efficiently researching and managing a current situation of a sign is described in Patent document 2. It is mentioned in the Patent document 2 that the sign can be more efficiently researched and managed.

[Patent document 1] JP-P2005-198252A

[Patent document 2] JP-P2006-209604A

However, with the system described in the Patent document 1, it is when the home network appliance has been connected to a home network that the home network appliance of which installation position information has not been registered yet is detected over the database, so this system necessitates a certain backbone network meditating between the home network appliance, being an object of a management of an installation position, and a managing system. On the other hand, there exist a lot of the ID originating devices, which only broadcast the ID information to a certain scope with unidirectional communication and are not in connection with the network in any way, in the positioning system employing the ID originating device, and with such an ID originating device, a detection as to whether or not the connection thereof to the network exists cannot be made from a viewpoint of the managing system, whereby the technique described in the Patent document 1 is not applicable to the above positioning system.

Further, the system described in the Patent document 2, which is a system for aiming at confirming whether or not the sign has been correctly installed in the location for which an application has been made in advance, demands two pieces of registered sign data and unregistered sign data as data for holding installation position information of the sign. The system described in the Patent document 2 is adapted so that the worker searches the registered sign data based upon a sign ID received in a working site, and registers the sign ID into the unregistered sign data only when it has not been registered yet into the registered sign data.

In the installation position registration of the ID originating device in the positioning system, in a case of having applied the technique described in the Patent document 2, the procedure could be taken in which after previously preparing data for deciding the location of installation schedule for each ID originating device, and installing all of the ID originating devices each of which is a target of installation, the worker confirms whether or not the ID originating device has been installed in the due location. However, with the positing system, it is difficult to previously prepare data for deciding the location of the installation schedule because the number and the installation position of the ID originating device largely depend upon an environment of the working site, and in addition hereto, its preparing work itself becomes a big burden upon the worker. That is, by taking the working procedure that the worker installs the ID originating device, and simultaneously therewith, registers the installation position into the system in the working site, the work is more efficiently done, and the technique described in the Patent document 2, which envisages the working procedure requiring the preparatory data is difficult to apply.

### SUMMARY OF THE INVENTION

Thereupon, the present invention has an object of, as one example, providing a registering system of ID originating device installation position information, a registering device of ID originating device installation position information, a registering method of ID originating device installation position information, and a registering program of ID originating device installation position information that make it possible to support the registration of the installation position information of the ID originating device, which is made at the time of constructing the positioning system, without demanding the preparatory data also in the system having no network between the ID originating device and the managing system.

The registering system of ID originating device installation position information in accordance with the present invention, which is a registering system of ID originating device installation position information for registering coordinate information of an installation position of an ID originating device and ID information being originated by the ID originating device correspondingly to each other into an installation position managing database, is characterized in including: an ID receiver for receiving the ID information being originated by the ID originating device; a position information input device for inputting the coordinate information; a map data reserve unit for holding map data; and an ID originating device position register for, at the moment the coordinate information on the map data is input while the ID information is being received, registering the ID information and the coordinate information correspondingly to each other into the installation position managing database.

The registering system of ID originating device installation position information in accordance with the present invention, being another aspect, which is a registering system of ID originating device installation position information for registering coordinate information of an installation position of an ID originating device and ID information being originated by the ID originating device correspondingly to each other into an installation position managing database, is characterized in including: an ID receiver for receiving the ID information being originated by the ID originating device; a position information input device for inputting the coordinate information; a map data reserve unit for holding map data; an ID originating device position register for, at the moment that the coordinate information on the map data is input while the ID information is being received, registering the ID information and the coordinate information correspondingly to each other into the installation position managing database; and an ID originating device installation position information acquire unit for acquiring the installation position information of the ID originating device already registered into the installation position managing database.

The registering device of ID originating device installation position information in accordance with the present invention, which is a registering device of ID originating device installation position information for registering coordinate information of an installation position of an ID originating device and ID information being originated by the ID originating device correspondingly to each other into an installation position managing database, is characterized in including: an ID receiver for receiving the ID information being originated by the ID originating device; a position information input device for inputting the coordinate information; a map data reserve unit for holding map data; and an ID originating device position register for, at the moment that the coordinate information on the map data is input while the ID information is being received, registering the ID information and the coordinate information correspondingly to each other into the installation position managing database.

The registering device of ID originating device installation position information in accordance with the present invention, being another aspect, which is a registering device of ID originating device installation position information for registering coordinate information of an installation position of an ID originating device and ID information being originated by the ID originating device correspondingly to each other into an installation position managing database, is characterized in including: an ID receiver for receiving the ID information being originated by the ID originating device; a position information input device for inputting the coordinate information; a map data reserve unit for holding map data; an ID originating device position register for, at the moment that the coordinate information on the map data is input while the ID information is being received, registering the ID information and the coordinate information correspondingly to each other into the installation position managing database; and an ID originating device installation position information acquire unit for acquiring the installation position information of the ID originating device already registered into the installation position managing database.

The registering method of ID originating device installation position information in accordance with the present invention, which is a registering method of ID originating device installation position information for registering coordinate information of an installation position of an ID originating device and ID information being originated by the ID originating device correspondingly to each other into an installation position managing database, is characterized in including: an ID receiving step of receiving the ID information being originated by the ID originating device; a position information inputting step of inputting the coordinate information; and an ID originating device position registering step of, at the moment that the coordinate information on map data being held by a map data reserve unit is input while the ID information is being received, registering the ID information and the coordinate information correspondingly to each other into the installation position managing database.

The registering method of ID originating device installation position information in accordance with the present invention, being another aspect, which is a registering method of ID originating device installation position information for registering coordinate information of an installation position of an ID originating device and ID information being originated by the ID originating device correspondingly to each other into an installation position managing database, is characterized in including: an ID receiving step of receiving the ID information being originated by the ID originating device; a position information inputting step of inputting the coordinate information; an ID originating device position registering step of, at the moment that the coordinate information on map data being held by a map data reserve unit is input while the ID information is being received, registering the ID information and the coordinate information correspondingly to each other into the installation position managing database; and an ID originating device installation position information acquiring step of acquiring the installation position information of the ID originating device already registered into the installation position managing database.

The registering program of ID originating device installation position information in accordance with the present invention, which is a registering program of ID originating device installation position information for registering coordinate information of an installation position of an ID originating device and ID information being originated by the ID originating device correspondingly to each other into an installation position managing database, is characterized in causing a computer to execute: an ID receiving process of receiving the ID information being originated by the ID originating device; a position information inputting process of inputting the coordinate information; and an ID originating device position registering process of, at the moment that the coordinate information on map data being held by a map data reserve unit is input while the ID information is being received, registering the ID information and the coordinate information correspondingly to each other into the installation position managing database.

The registering program of ID originating device installation position information in accordance with the present invention, being another aspect, which is a registering program of ID originating device installation position information for registering coordinate information of an installation position of an ID originating device and ID information being originated by the ID originating device correspondingly to each other into an installation position managing database, is characterized in causing a computer to execute: an ID receiving process of receiving the ID information being originated by the ID originating device; a position information inputting process of inputting the coordinate information; an ID originating device position registering process of, at the moment that the coordinate information on map data being held by a map data reserve unit is input while the ID information is being received, registering the ID information and the coordinate information correspondingly to each other into the installation position managing database; and an ID originating device installation position information acquiring process of acquiring the installation position information of the ID originating device already registered into the installation position managing database.

The first invention for solving the above-mentioned problems, which is a system for registering coordinate information of an installation position of an ID originating device and ID information being originated by the ID originating device correspondingly to each other into an installation position managing database, is characterized in including: an ID acquire unit for receiving the ID information being originated by the ID originating device; a position information input device for inputting the coordinate information; a map data reserve unit for holding the map data; and an ID originating device position register for, at the moment that the coordinate information on the map data is input while the ID information is being received, registering the ID information and the coordinate information correspondingly to each other into the installation position managing database.

The second invention for solving the above-mentioned problems is characterized in that, in the above-mentioned first invention, in a case where, at the moment of registering the ID information and the coordinate information into the installation position managing database, the identical ID information has already been registered into the installation position managing database, the ID originating device position register updates the coordinate information of the already registered ID information based upon coordinate information input newly by the position information input device.

The third invention for solving the above-mentioned problems is characterized in that, in one of the above-mentioned first and second inventions, the position information input device provides a coordinate information input user interface screen for inputting the coordinate information of the installation position of the ID originating device, which is configured of a reception ID display for displaying the ID information acquired by the ID acquire unit and a map display for displaying a map image of the location in which the ID originating device is installed, to a terminal that a user who does a work of registering the installation position of the ID originating device has, and inputs the installation position coordinates of the ID originating device as coordinate information on the map image according to an operation of directly designating the position on the map image that is displayed on the map display as installation position coordinates of the ID originating device.

The fourth invention for solving the above-mentioned problems is characterized in that, in the above-mentioned third invention, the coordinate information input user interface screen is configured of a reception ID display for displaying the ID information acquired by the ID acquire unit, a map display for displaying the map image of the location in which the ID originating device is installed, and a map selector for selecting the map image of the location in which the ID originating device is installed, and the installation position coordinates of the ID originating device are input as coordinate information on the map image selected by the map selector.

The fifth invention for solving the above-mentioned problems, which is a system for registering coordinate information of an installation position of an ID originating device and ID information being originated by the ID originating device correspondingly to each other into an installation position managing database, is characterized in including: an ID acquire unit for receiving the ID information being originated by the ID originating device; a position information input device for inputting the coordinate information; a map data reserve unit for holding map data; an ID originating device position register for, at the moment that the coordinate information on the map data is input while the ID information is being received, registering the ID information and the coordinate information correspondingly to each other into the installation position managing database; and an ID originating device installation position information acquire unit for acquiring the installation position information of the ID originating device already registered into the installation position managing database.

The sixth invention for solving the above-mentioned problems is characterized in that, in the above-mentioned fifth invention, in a case where, at the moment of registering the ID information and the coordinate information into the installation position managing database, the identical ID information has already been registered into the installation position managing database, the ID originating device position register updates the coordinate information of the already registered ID information based upon coordinate information input newly by the position information input device.

The seventh invention for solving the above-mentioned problems is characterized in that, in one of the above-mentioned fifth and sixth inventions, the position information input device provides a coordinate information input user interface screen for inputting the coordinate information of the installation position of the ID originating device, which is configured of a reception ID display for displaying the ID information acquired by the ID acquire unit and a map display for displaying a map image of the location in which the ID originating device is installed, to a terminal that a user who does a work of registering the installation position of the ID originating device has, and inputs the installation position coordinates of the ID originating device as coordinate information on the map image according to an operation of directly designating the position on the map image that is displayed on the map display as an installation position coordinates of the ID originating device.

The eighth invention for solving the above-mentioned problems is characterized in that, in the above-mentioned seventh invention, the coordinate information input user interface screen is configured of a reception ID display for displaying the ID information acquired by the ID acquire unit, a map display for displaying the map image of the location in which the ID originating device is installed, and a map selector for selecting the map image of the location in which the ID originating device is installed, and the installation position coordinates of the ID originating device are input as coordinate information on the map image selected by the map selector.

The ninth invention for solving the above-mentioned problems is characterized in that, in one of the above-mentioned seventh and eighth inventions, including an ID originating device installation position information acquire unit for acquiring the installation position information of the ID originating device already registered into the installation position managing database, and in a case where, at the moment of displaying the map image on the map display of the coordinate information input user interface screen, the ID originating device already registered into the identical map image exists, displaying an ID originating device icon indicative of the ID originating device on the map image of the map display based upon the coordinate information registered into the database.

The tenth invention for solving the above-mentioned problems is characterized in that, in one of the above-mentioned seventh to ninth inventions, including an ID originating device installation position information acquire unit for acquiring the installation position information of the ID originating device already registered into the database, and displaying whether or not the ID originating device having the ID information acquired by the ID acquire unit has been registered into the database on the ID display of the user interface screen.

The present invention makes it possible to support a work of registering the installation position information of the ID originating device without demanding preparatory data also in the positioning system having no network between the ID originating device and the managing system.

### BRIEF DESCRIPTION OF THE DRAWINGS

This and other objects, features and advantages of the present invention will become more apparent upon a reading of the following detailed description and drawings, in which:

FIG. 1 is a block diagram illustrating one example of an entire configuration of the registering system of ID originating device installation position information in accordance with the present invention;

FIG. 2 is a block diagram illustrating an example of a configuration of a worker terminal and an installation position managing server;

FIG. 3 is an explanatory view illustrating an example of information that an installation position management database stores;

FIG. 4 is an explanatory view illustrating an example of a user interface screen that a position information inputting unit provides to a user of the worker terminal;

FIG. 5 is a flowchart illustrating a process of the registering system of the ID originating device installation position information in a first exemplary embodiment;

FIG. 6 is an explanatory view illustrating an example of an operation in the user interface screen;

FIG. 7 is an explanatory view illustrating an example of a confirmation display screen;

FIG. 8 is an explanatory view illustrating another example of information that the installation position management database stores;

FIG. 9 is an explanatory view illustrating an example of the user interface screen;

FIG. 10 is a flowchart illustrating one example of a process of the registering system of the ID originating device installation position information in a modification example of the first exemplary embodiment;

FIG. 11 is a block diagram illustrating an example of a configuration of the installation position managing server in second exemplary embodiment;

FIG. 12 is an explanatory view illustrating an example of the user interface screen that the position information inputting unit provides to a user of the worker terminal in the second exemplary embodiment; and

FIG. 13 is a flowchart illustrating one example of a process of the registering system of the ID originating device installation position information in the second exemplary embodiment.

### EXEMPLARY EMBODIMENTS

Hereinafter, the present invention will be explained by making a reference to the accompanied drawings.

### Exemplary Embodiment 1

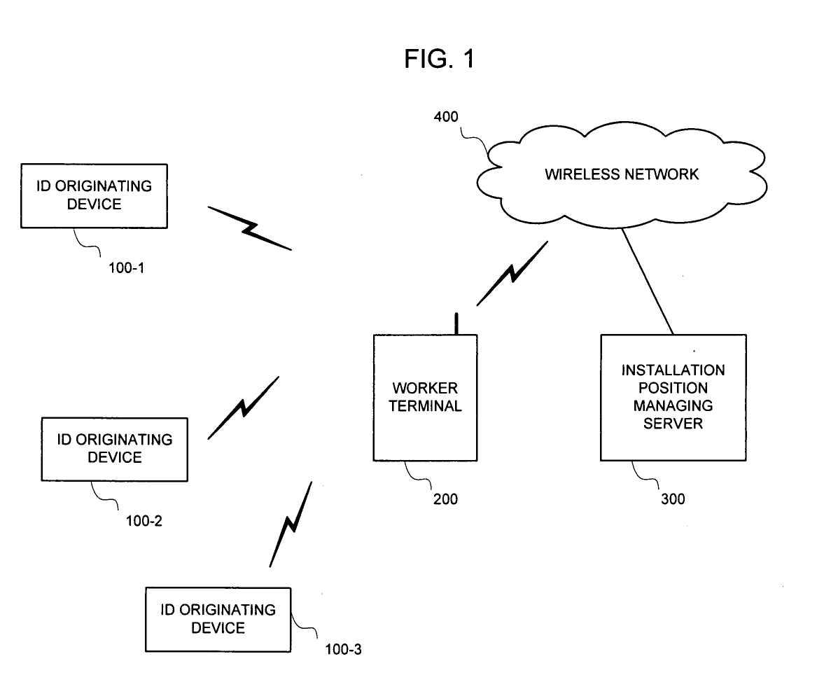

At first, the first exemplary embodiment will be explained. FIG. 1 is a block diagram illustrating one example of an entire configuration of the registering system of the ID originating device installation position information in accordance with the present invention.

In the figure shown in FIG. 1, an ID originating device installation position managing system (a registering system of the ID originating device installation position information) includes a plurality of ID originating devices 100-1, 100-2, and 100-3 for broadcasting an inherent ID signal to a certain scope by employing a radio signal with infrared communication or Bluetooth, one worker terminal or a plurality of worker terminals 200 that a worker uses at the moment of registering the installation positions of the ID originating devices 100-1, 100-2, and 100-3, and an installation position managing server 300 that can make communication with the worker terminal 200 via a wireless network 400.

Additionally, hereinafter, the ID originating devices 100-1, 100-2, and 100-3 plurally shown in FIG. 1 will be explained by employing an ID originating device 100. For example, at the time of comprehensively indicating the ID originating devices 100-1, 100-2, and 100-3, or at the time of indicating one of the ID originating devices 100-1, 100-2, and 100-3, as is often the case, the expression of the ID originating device 100 is used. Further, in this exemplary embodiment, the case that the number of the ID originating device 100 is three is shown; however, the number is not limited to three, and, for example, it could be four or more.

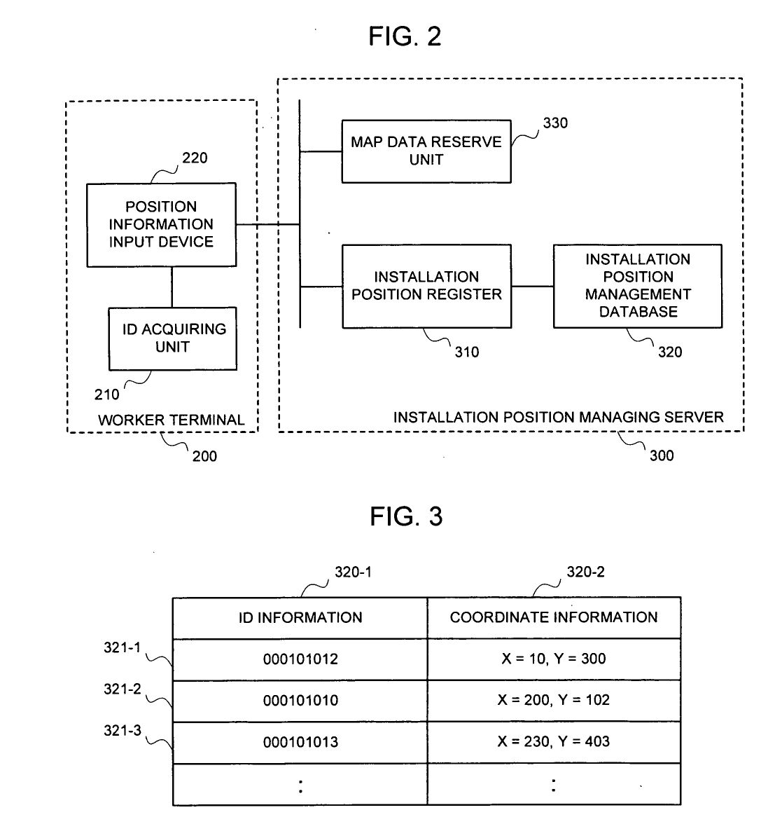

FIG. 2 is a block diagram illustrating an example of a configuration of the worker terminal 200 and the installation position managing server 300. The worker terminal 200 is realized, for example, with the information processing terminal such as a portable telephone that operates according to a program. The worker terminal 200 includes an ID acquiring unit 210 for receiving ID information being transmitted by the ID originating device 100, and a position information input device 220 for providing an user interface for inputting installation position information of the ID originating device 100 to a worker.

Further, the installation position managing server 300 is realized, for example, with the information processing terminal such as a personal computer that operates according to a program. The installation position managing server 300 includes an installation position register 310 for executing the installation position registration of the ID originating device 100, an installation position management database 320 for recording the installation position information of the ID originating device 100, and a map data reserve unit 330 for holding map data.

Additionally, in an example of the configuration shown in FIG. 1 and FIG. 2, the case that the worker terminal 200 and the installation position managing server 300 each of which existed on a different machine (information processing terminal) were connected via the wireless network 400 was shown; however, they may be connected via a wire network. Further, each of the worker terminal 200 and the installation position managing server 300 does not need to be always configured on a physically different machine, and the case as well that the worker terminal 200 holds a function of the installation position managing server 300 therein is thinkable.

FIG. 3 is an explanatory view illustrating an example of information that the installation position management database 320 stores. As indicated by the example shown in FIG. 3, the installation position management database 320 stores information including ID information 320-1 being transmitted by each ID originating device, and coordinate information 320-2, being installation position information of each ID originating device, as installation position information of each ID originating device 100.

Additionally, the installation position management database 320, as indicated by an example shown in FIG. 3, registers the coordinate information correspondingly to the ID information in such forms of entries 321-1, 321-2, and 321-3 with the ID information 320-1 being transmitted by each ID originating device assumed to be a unique key of the database.

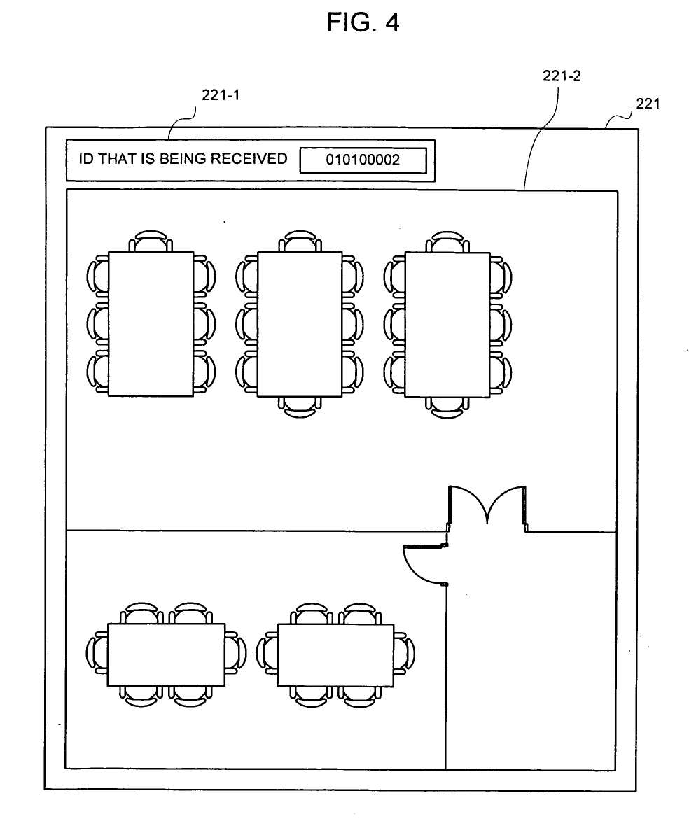

FIG. 4 is an explanatory view illustrating an example of a user interface screen 221 that the position information input device 220 provides to a user (worker) of the worker terminal 200. In the example shown in FIG. 4, when ID information that the ID acquiring unit 210 is receiving exists, the user interface screen 221 includes a reception ID display 221-1 for displaying its ID information, and a map display 221-2 for displaying map data. In addition, specifically, the worker terminal 200 displays the user interface screen 221 shown in FIG. 4. Further, the so-called provision of the user interface screen signifies that the worker terminal 200 is caused to display the user interface screen 221.

Additionally, the registering system of the ID originating device installation position information can be realized with a computer, and each component constituting the registering system of the ID originating device installation position information, i.e. each of the ID acquiring unit 210, the position information input device 220, and the installation position register 310 can be realized as a program for causing a processing unit of the computer (CPU) to realize the foregoing function. For example, so as to realize the registering system of the ID originating device installation position information by employing one information processing terminal, a storage device of the information processing terminal needs to store a registering program of the ID originating device installation position information for causing the computer to execute the ID receiving process of receiving the ID information being originated by the ID originating device; the position information inputting process of inputting the coordinate information; and the ID originating device position registering process of, at the moment that the coordinate information on the map data being held by the map data reserve unit is input while the ID information is being received, registering the ID information and the coordinate information correspondingly to each other into the installation position managing database, and further for causing the computer to execute the ID originating device position registering process of, in a case where, at the moment of registering the ID information and the coordinate information into the installation position managing database, the identical ID information has already been registered into the installation position managing database, updating the coordinate information of the already registered ID information based upon coordinate information input newly in the position information inputting process.

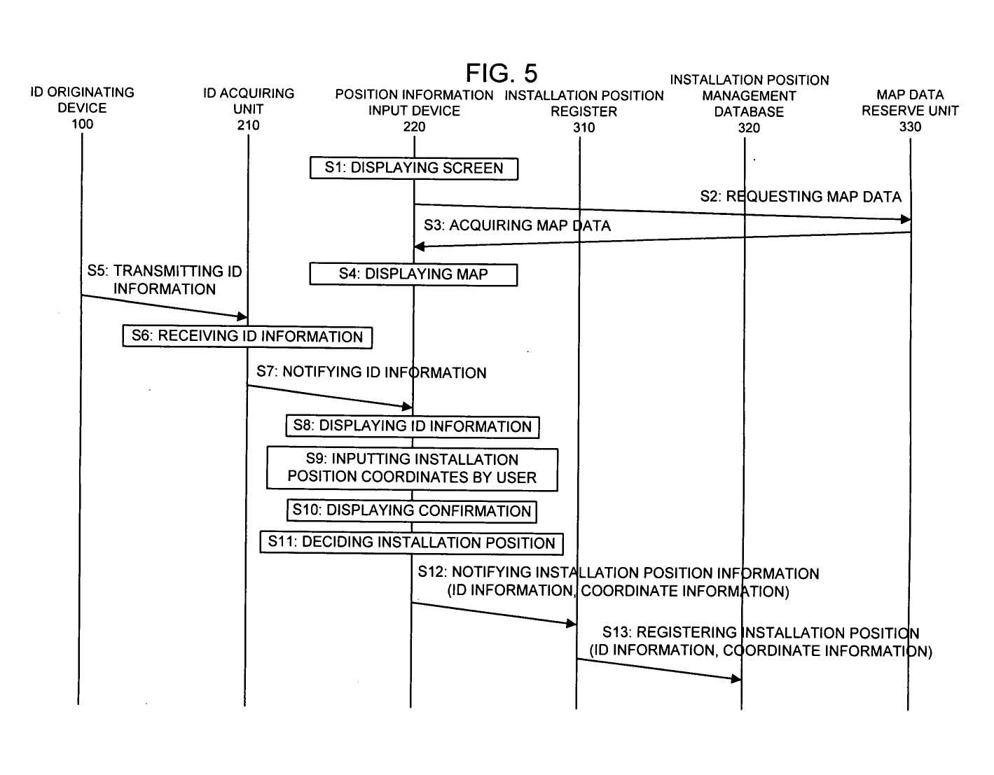

FIG. 5 is a flowchart illustrating a process of the registering system of the ID originating device installation position information in the first exemplary embodiment. An operation of this exemplary example will be explained by making a reference to a flowchart shown in FIG. 5 and an example (FIG. 4) of the configuration of the user interface screen 221.

Firstly, at the moment of starting a registering work, the worker terminal 200 is activated according to a worker's (user's) operation and displays the user interface screen 221 being provided by the position information input device 220 (step S1). Then, the position information input device 220 requests map data of the map data reserve unit 330 (step S2), acquires (receives) the map data (step S3), and displays it on the map display 221-2 (step S4).

Specifically, the position information input device 220 transmits to the installation position managing server 300 a request for transmitting map data via the wireless network 400. The installation position managing server 300, responding to a request by the position information input device 220, extracts map data from the map data reserve unit 330. And, the installation position managing server 300 transmits the extracted map data to the position information input device 220 via the wireless network 400.

Next, when the worker carrying the worker terminal 200 migrates to the location into which the ID originating device 100 has been actually installed, each ID originating device 100 transmits the ID information to the ID acquiring unit 210 of worker terminal 200 (Step S5). When the ID acquiring unit 210 of worker terminal 200 receives the ID information being transmitted by each ID originating device 100 (Step S6), the ID acquiring unit 210 notifies (outputs) the received ID information to the position information input device 220 (Step S7). Then, the position information input device 220 displays the received ID information on the reception ID display 221-1 of the user interface screen 221 (Step S8).

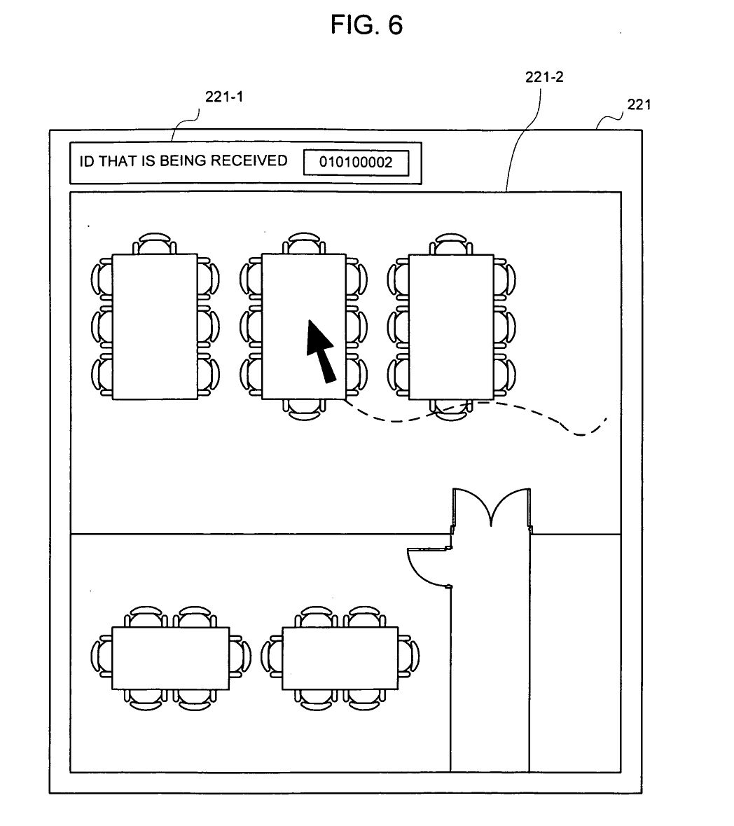

FIG. 6 is an explanatory view illustrating an example of an operation in the user interface screen 221. After the worker confirms the ID information displayed on the reception ID display 221-1, as shown in FIG. 6, he/her directly inputs the location into which the installation position of this ID originating device 100 is registered onto the map display 221-2 with an pointing operation employing a mouse, a stylus, touch panel, or the like of the worker terminal 200 (Step S9).

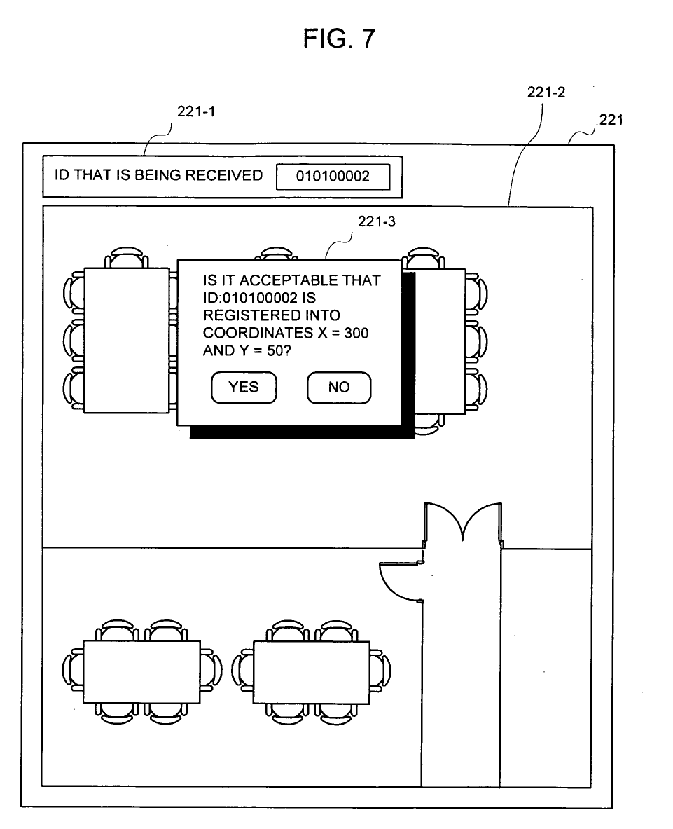

Then, the position information input device 220 detects a coordinate position on its map, and displays a confirmation displaying screen 221-3 shown in FIG. 7 (Step S10). FIG. 7 is an explanatory view illustrating an example of the confirmation display screen. After confirming the input position, the worker selects “Yes” of the confirmation displaying screen 221-3, thereby allowing the position information input device 220 to decide the coordinate information input in the step S9 by the worker as installation position information (Step S11).

Next, the position information input device 220 notifies the ID information and the coordinate information to the installation position register 310 with the coordinate information decided in the step S11 assumed to be new installation position information of the ID originating device 100 (Step S12). Specifically, the position information input device 220 transmits the new installation position information to the installation position register 310 via the wireless network 400. The installation position register 310 causes the installation position management database 320 to additionally store the new installation position information of the ID originating device 100 based upon the information notified in the step S12 (Step S13). Additionally, in the step S13, in a case where, at the moment of registering the ID information into the installation position management database 320, the entry having the identical ID information has already been registered, the installation position register 310 does not add the entry newly, but updates the entry of its ID information based upon the information notified in the step S13.

### MODIFICATION EXAMPLE 1

Next, the case that the map data for registering the installation position of the ID originating device 100 exists plurally will be explained as a modification example 1 of the first exemplary embodiment.

In the foregoing first exemplary embodiment, the explanation was made on the premise that the number of the piece of the map data for registering the installation position of the ID originating device 100 was one (1); however, as a matter of fact, the case as well that plural pieces of the map data exist is thinkable.

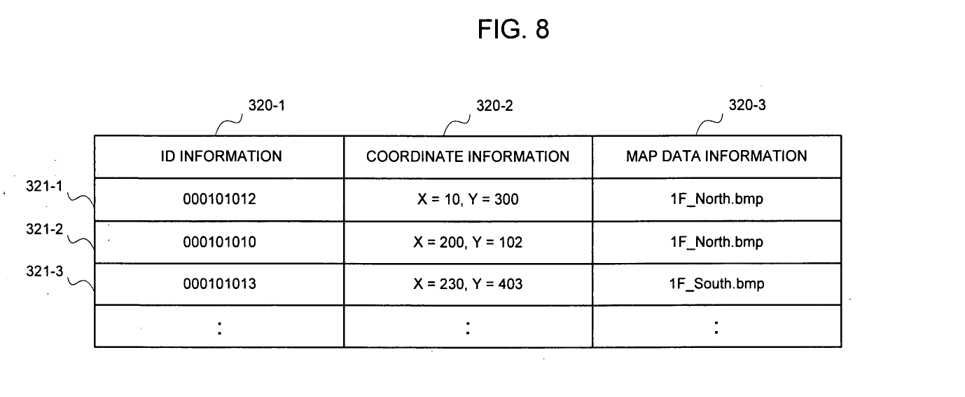

FIG. 8 is an explanatory view illustrating another example of information that the installation position management database 320 stores. When plural pieces of the map data exist, as shown in FIG. 8, for the installation position management database 320, it newly becomes necessary to store a map data information 320-3 correspondingly to the ID information into the installation position as a parameter for identifying which map data is employed for registering the position of each ID originating device 100.

In an example shown in FIG. 8, the case of having registered a file name of the map data into the map data information 320-3 is shown; however the parameter is not limited to the file name, and the information with which the map data can be specified, for example, URL information indicative of a storage location of the map data is made registrable.

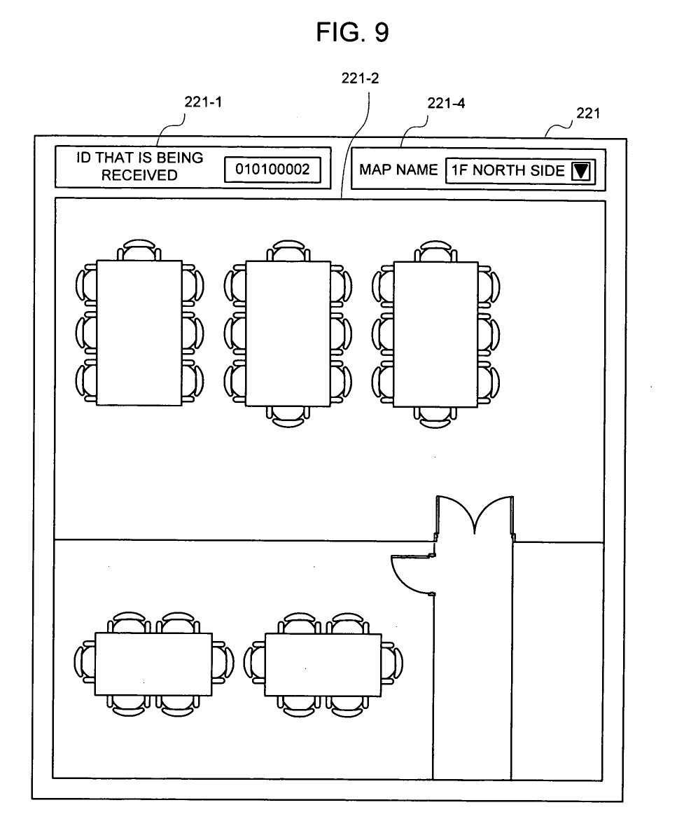

Further, when plural pieces of the map data exist, it is necessary that the worker is able to select the map data at the moment of registering the installation position of the ID originating device 100. For this, as shown in FIG. 9, the user interface screen 221 necessitates a map selector 221-4 that makes the map data selectable with a pull-down menu or the like. FIG. 9 is an explanatory view illustrating an example of the user interface screen 221. In addition, specifically, the worker terminal 200 displays the user interface screen 221 shown in FIG. 9.

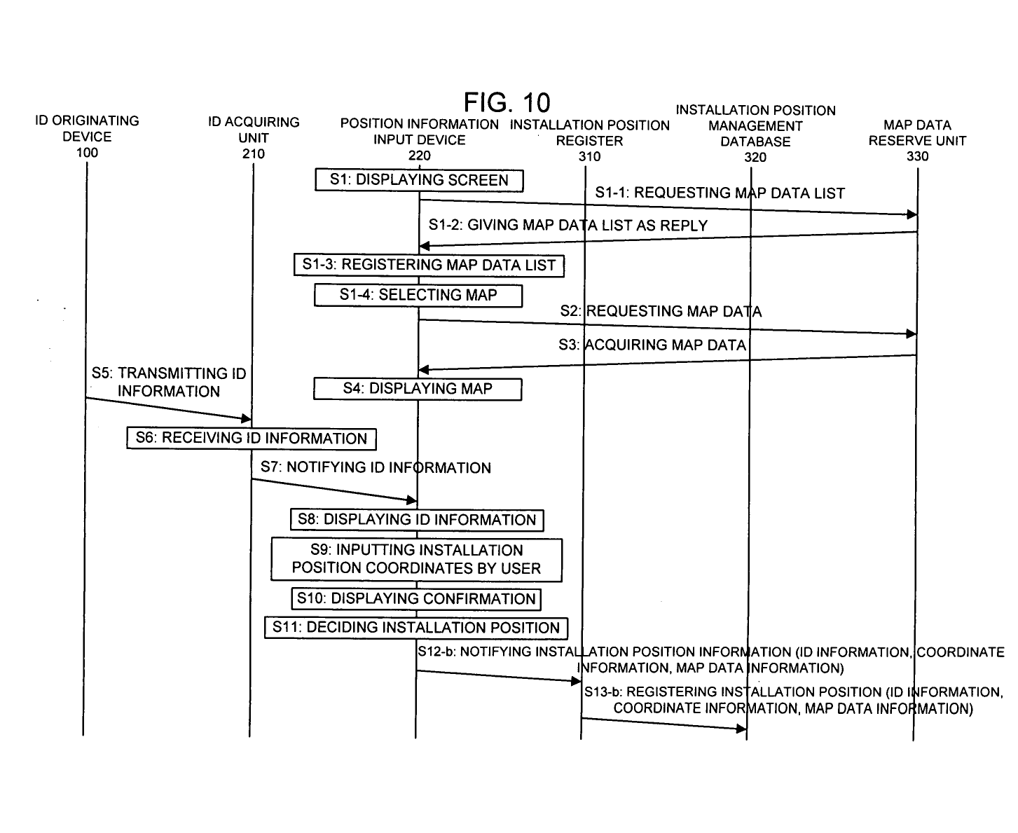

Next, an entire operation in this modification example will be explained by employing a flowchart shown in FIG. 10. FIG. 10 is a flowchart illustrating one example of a process of the registering system of the ID originating device installation position information in the modification example of the first exemplary embodiment. Additionally, an identical numeral code is affixed to a portion identical to the operation in the first exemplary embodiment shown in FIG. 5, and its explanation is omitted.

As shown in FIG. 10, in this modification example, after the worker terminal 200 is activated according to a worker's operation, and displays the user interface screen 221 (step S1), the position information input device 220 requests a map data list (a list of information for enabling the map data to be specified, for example, a map file name) being held by the map data reserve unit 330 of the map data reserve unit 330 (step S1-1).

Specifically, the position information input device 220 transmits to the installation position managing server 300 a request for transmitting the map data list via the wireless network 400. The installation position managing server 300, responding to a request by the position information input device 220, extracts the map data list from the map data reserve unit 330. And, the installation position managing server 300 transmits the extracted map data list to the position information input device 220 via the wireless network 400.

And, the position information input device 220 acquires (receives) the map data list (step S1-2), and registers a list of the map data information into a pull-down menu of the map selector 221-4 of the user interface screen 221 or the like (step S1-3). Further, the position information input device 220 displays the user interface screen 221 including a list of the map data information according to the registration text.

And, the worker selects the map data, which is used for a work of registering the installation position information of the ID originating device 100, from among the map data list of the map selector 221-4 by employing the map selector 221-4 in the step S1-4, thereby allowing the position information input device 220 to acquire (receive) the map data from the map data reserve unit 330 and to display the selected map data on the map display 221-2.

The process subsequent hereto is identical to the process shown in FIG. 5 except for a point that the map data information for specifying the map data is added to the information being notified (transmitted) in step S11 and step S12.

The configuration shown in this modification example above enables the worker to select and register the map data for registering the installation position coordinates of the ID originating device 100 also when plural pieces of the map data exist.

Next, an effect of the first exemplary embodiment and its modification example 1 will be explained. In accordance with the first exemplary embodiment and its modification example 1 explained above, also in a case of registering the installation position information of the ID originating device 100 having no backbone network, by employing the worker terminal 200 that is capable of receiving the ID information being transmitted from the ID originating device 100, and yet performing the registering operation at the moment that the worker actually installs the ID originating device 100 or confirms the operation of the ID originating device 100, the installation position information can be registered at its site. Further, the first exemplary embodiment and its modification example 1 make it possible to register the installation position information without demanding the preparatory data.

Further, in accordance with the present invention, the ID information of which the registration has been made by the worker terminal 200 is registered as data identical to the data registered into the installation position management database 320. For example, when a request is made for registering the ID information identical to the already registered record, its record is updated.

### A Second Exemplary Embodiment

Next, the second exemplary embodiment will be explained by making a reference to the accompanied drawings.

In the technology described in the Patent document 2, the worker searches the sign registration database based upon the sign ID acquired from the RFID of the sign. And he/her determines whether or not to register its sign ID into the unregistered sign database based upon its search result.

Herein, the information, which is obtained as a search result, is not installation position information of the sign actually installed, but installation position schedule information prepared based upon the preparatory application information. Further, only installation position schedule information of the sign that corresponds to the received sign ID of the RFID is obtained as a search result. For this, even though the technique described in the Patent document 2 is applied for the work of registering the installation position information of the ID originating device, the worker cannot confirm the registration situation of the installation position information of the ID originating device in the neighborhood of the current location or in a specific area in the course of the work being done.

Furthers with the ID originating device, each ID originating device is basically identical in a shape, which is different from the case of the sign. For this, it is difficult for the worker to remember which ID originating device has been already registered, and which ID originating device has not been registered yet, and when the worker forgets the registration situation, he/her has to do such a work of migrating to the installation location of the ID originating device one by one once again, and individually receiving and confirming the ID. In particular, when a plurality of the workers do the registering work simultaneously, a lot of the useless works occur all the more because how each registration progresses cannot be confirmed.

Thereupon, the second exemplary embodiment enables the registering work to be done efficiently by providing the registering system of the ID originating device installation position information capable of confirming the registration situation of the installation position information of the ID originating device in the adjacent of the current position of the workers.

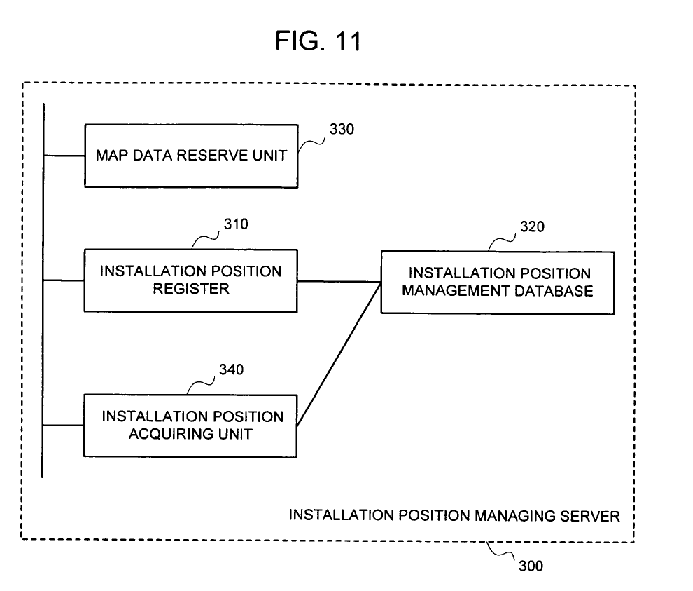

FIG. 11 is a block diagram illustrating an example of a configuration of the installation position managing server 300 in the second exemplary embodiment. Additionally, an identical name and an identical numeral code are affixed to a portion having a function identical to that of the first exemplary embodiment previously explained, and its explanation is omitted. As shown in FIG. 11, it is in a point that an installation position acquiring unit 340 for acquiring (receiving) the installation position information of the already installed ID originating device 100 is added that the second exemplary embodiment differs from the first exemplary embodiment.

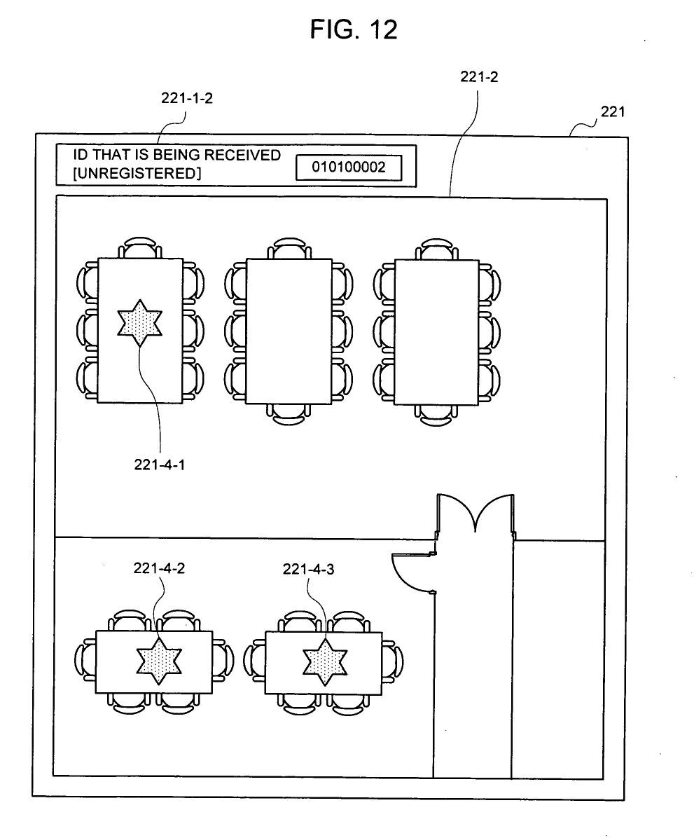

Further, FIG. 12 is an explanatory view illustrating an example of the user interface screen 221 that the position information input device 220 provides to a user (worker) of the worker terminal 200 in the second exemplary embodiment. Additionally, an identical numeral code is affixed to a portion identical to that of the first exemplary embodiment, and its explanation is omitted.

As shown in FIG. 12, in the second exemplary example, the position information input device 220 additionally displays on a reception ID display 221-1-2, in which ID information that is being received is displayed, information indicating whether or not its ID information has already been registered into the installation position management database 320.

In an example shown in FIG. 12, in a case of having received the ID information not registered into the installation position management database 320, the position information input device 220 displays it as “unregistered”. And, in a case of having received the ID information already registered into the installation position management database 320, the position information input device 220 displays it as “already registered”, which is not shown in the figure.

Further, in the second exemplary embodiment, when an ID originating device 100 already registered into the map that is being displayed exists, the position information input device 220 displays ID originating device icons 221-4-1, 221-4-2, and 221-4-3 indicative of its ID originating device 100 on the map display 221-2 based upon coordinate information 320-2 of each ID originating device 100 registered into the installation position management database 320.

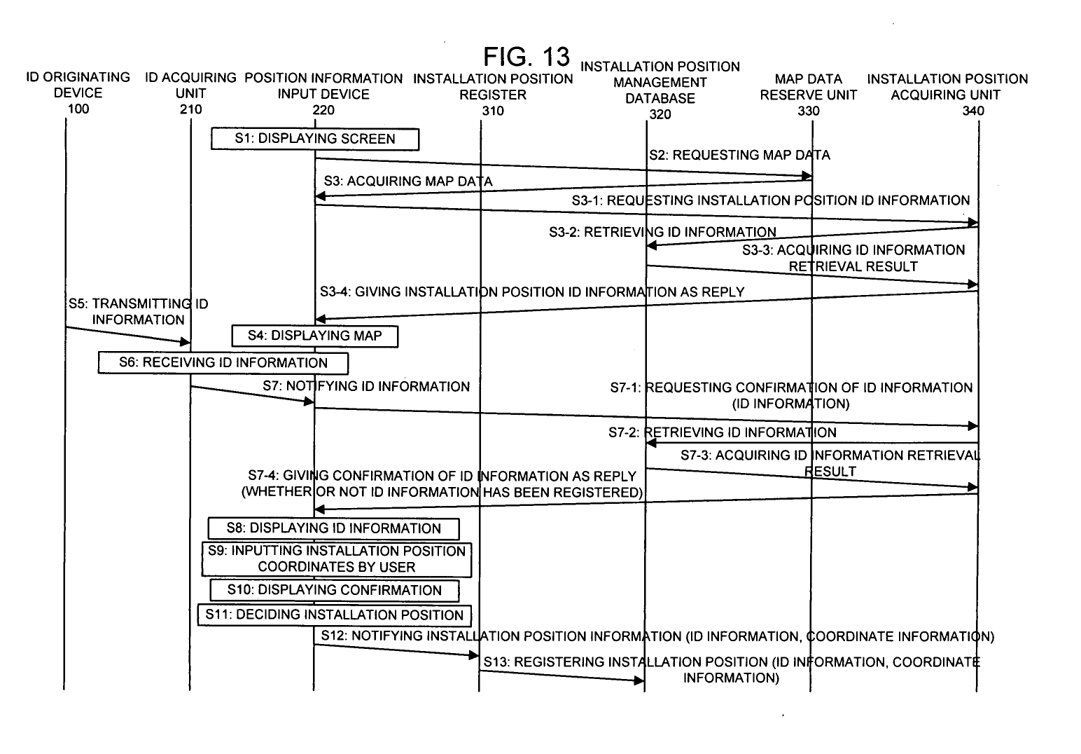

Next, an entire operation in the second exemplary embodiment will be explained by making a reference to the accompanied drawings. FIG. 13 is a flowchart illustrating one example of a process of the registering system of the ID originating device installation position information in the second exemplary embodiment. The entire operation in the second exemplary embodiment is shown in a flowchart of FIG. 13. Additionally, an identical numeral code is affixed to a portion identical to the operation in the first exemplary embodiment shown in FIG. 5, and its explanation is omitted.

As shown in FIG. 13, in the second exemplary example, after the step S3, the position information input device 220 requests the already registered ID information of an installation position acquiring unit 340 (step S3-1). The installation position acquiring unit 340 having received the request searches the installation position management database 320 (step S3-2), acquires (receives) the already registered installation position information (step S3-3), and returns the ID information and the coordinate information to the position information input device 220 (step S3-4). Additionally, the so-called acquisition of the installation position information, specifically, signifies extraction of the installation position information from the installation position management database 320.

Specifically, the position information input device 220 transmits to the installation position acquiring unit 340 a request for transmitting the already registered ID information via the wireless network 400. The installation position acquiring unit 340, responding to a request by the position information input device 220, extracts the already registered installation position information from the installation position management database 320. And, the installation position acquiring unit 340 transmits to the position information input device 220 via the wireless network 400 the extracted installation position information already registered.

Next, in a case where, at the moment of displaying the map in the step S3-3, the already registered ID originating device 100 exists, as shown in FIG. 12, the position information input device 220 displays the ID originating device icons 221-4-1, 221-4-2, and 221-4-3 based upon a result obtained in the step S3-4.

Further, in the second exemplary embodiment, the position information input device 220 having received a notification of ID information from the ID acquiring unit 210 in the step S7 transmits a confirmation request for confirming whether or not its ID information has already registered into the installation position management database 320 to the installation position acquiring unit 340 (step S7-1).

The installation position acquiring unit 340 receives the confirmation request (step S7-2), and searches the installation position management database 320 (step S7-3). Herein, in a case of having acquired (received) the installation position information, being corresponding ID information, the installation position acquiring unit 340 returns a reply indicating that the ID information has been registered to the position information input device 220. Further, in a case where the installation position information has not been registered yet, the installation position acquiring unit 340 returns a reply indicating that the ID information has not been registered yet to the position information input device 220 (step S7-4).

Next, at the moment that the position information input device 220 displays the ID information on the reception ID display 221-1-2 of the user interface screen 221 in the step S8, it displays one of “unregistered” and “already registered” together with the ID information that is being received, based upon a reply result obtained in the step S7-4.

Herein, as shown in the modification example 1 of the first exemplary embodiment, when plural pieces of the map data exist and yet the ID information received by the ID acquiring unit 210 has been already registered onto map data different from the map data that is being displayed, the screen indicating that the ID information has already been registered into another map data is displayed with a popup display or the like. Further, with a menu on the identical screen, it is made selectable whether or not the worker switches the map data, which is displayed on the map display 221-2, to the map data into which its ID information has been registered.

Additionally, a process of step S8 to step S13 subsequent hereto is identical to that of first exemplary embodiment, so its explanation is omitted.

Next, an effect of the second exemplary embodiment will be explained. As explained above, in the second exemplary embodiment, the installation position information of the ID originating device 100 from which the ID has been newly received becomes registable after the worker (user) has confirmed the already registered ID originating device 100. Further, making it confirmable whether the received ID information is already-registered information enables the useless work such that the worker registers the identical ID information many times as a result of having forgot which ID information has already been registered while it is registering many pieces of the ID information to be prevented from occurring. Further, also when a plurality of the workers do the registering work simultaneously, how each registration progresses can be confirmed. That is, the second exemplary embodiment has an effect that the registering work can be more efficiently done.

Additionally, in each exemplary embodiment shown above, the characteristic configurations of the registering system of the ID originating device installation position information as shown in the following (1) to (10) are exhibited.

(1) The registering system of the ID originating device installation position information, which is a registering system of ID originating device installation position information for registering coordinate information of an installation position of an ID originating device (which, for example, is realized with the ID originating device 100) and ID information being originated by the ID originating device correspondingly to each other into an installation position managing database (which, for example, is realized with the installation position managing database unit 320), is characterized in including: an ID receiver (which, for example, is realized with the ID acquiring unit 210) for receiving the ID information being originating by the ID originating device; a position information input device (which, for example, is realized with the position information input device 220) for inputting the coordinate information; a map data reserve unit (which, for example, is realized with the map data reserve unit 330) for holding map data; and an ID originating device position register (which, for example, is realized with the installation position register 310) for, at the moment that the coordinate information on map data is input while the ID information is being received, registering the ID information and the coordinate information correspondingly to each other into the installation position managing database.

(2) The ID originating device position register may be configured so that, in a case where, at the moment of registering the ID information and the coordinate information into the installation position managing database, the identical ID information has already been registered into the installation position managing database, it updates the coordinate information of the already registered ID information based upon coordinate information input newly by the position information input device.

(3) The position information input device may be configured to provide a coordinate information input user interface screen for inputting the coordinate information of the installation position of the ID originating device to a terminal that a user who does a work of registering the installation position of the ID originating device has, to cause the terminal to display a screen including a reception ID display for displaying the ID information received by the ID receiver and a map display for displaying a map image of the location in which the ID originating device is installed as the coordinate information input user interface screen, and to input the installation position coordinates of the ID originating device as coordinate information on the map image according to the operation of directly designating the position on the map image, which is displayed on the map display as installation position coordinates of the ID originating device.

(4) The position information input device may be configured to causes the terminal to display a screen including a reception ID display for displaying the ID information received by the ID receiver, a map display for displaying a map image of the location in which the ID originating device is installed, and a map selector for selecting the map image of the location in which the ID originating device is installed as a coordinate information input user interface screen, and to input the installation position coordinates of the ID originating device as coordinate information on the map image selected by the map selector.

(5) The registering system of the ID originating device installation position information, which is a registering system of ID originating device installation position information for registering coordinate information of an installation position of an ID originating device and ID information being originated by the ID originating device correspondingly to each other into an installation position managing database, is characterized in including: an ID receiver for receiving the ID information being originated by the ID originating device; a position information input device for inputting the coordinate information; a map data reserve unit for holding map data; an ID originating device position register for, at the moment that the coordinate information on the map data is input while the ID information is being received, registering the ID information and the coordinate information correspondingly to each other into the installation position managing database; and an ID originating device installation position information acquire unit (which is realized, for example, with the installation position acquiring unit 340) for acquiring the installation position information of the ID originating device already registered into the installation position managing database.

(6) The ID originating device position register may be configured so that, in a case where, at the moment of registering the ID information and the coordinate information into the installation position managing database, the identical ID information has already been registered into the installation position managing database, it updates the coordinate information of the already registered ID information, based upon coordinate information input newly by the position information input device.

(7) The position information input device may be configured to provide a coordinate information input user interface screen for inputting the coordinate information of the installation position of the ID originating device to a terminal that a user who does a work of registering the installation position of the ID originating device has, to cause the terminal to display a screen including a reception ID display for displaying the ID information received by the ID receiver and a map display for displaying a map image of the location in which the ID originating device is installed as the coordinate information input user interface screen, and to input the installation position coordinates of the ID originating device as coordinate information on the map image, according to the operation of directly designating the position on the map image that is displayed on the map display as installation position coordinates of the ID originating device.

(8) The position information input device may be configured to cause the terminal to display a screen including a reception ID display for displaying the ID information received by the ID receiver, a map display for displaying the map image of the location in which the ID originating device is installed, and a map selector for selecting the map image of the location in which the ID originating device is installed as a coordinate information input user interface screen, and to input the installation position coordinates of the ID originating device as coordinate information on the map image selected by the map selector.

(9) The position information input device may be configured so that, in a case where, at the moment of displaying the map image on the map display of the coordinate information input user interface screen, the ID originating device already registered into the identical map image exists, it displays an ID originating device icon indicative of the ID originating device on the map image, based upon the coordinate information registered into the installation position managing database.

(10) The position information input device may be configured to display whether or not the ID originating device having the ID information received by the ID receiver has been registered into the installation position managing database on the reception ID display of the coordinate information input user interface screen.

The present invention is applicable to an application for supporting a work that is done at the moment of registering the installation position information of each ID originating device in a positioning system for acquiring a current position of a mobile terminal, by pre-installing a large number of the ID originating devices each of which has ID information for identifying itself, and yet transmits this ID information to a certain scope with infra-red communication, RF-ID, Bluetooth or the like in a space to search a database into which the installation position information of each ID originating device has been registered from the ID information received from the ID originating device by the mobile terminal such as a portable telephone.

While the invention has been particularly shown and described with reference to exemplary embodiments thereof, the invention is not limited to these exemplary examples. It will be understood by those of ordinary skill in the art that various changes in form and details may be made therein without departing from the spirit and scope of the present invention as defined by the claims.

What is claimed is:

1. A registering system of ID originating device installation position information for registering coordinate information of an installation position of an ID originating device and ID information being originated by said ID originating device correspondingly to each other into an installation position managing database, said registering system comprising:
an ID receiver for receiving the ID information being originated from said ID originating device;
a position information input device for inputting the coordinate information;
a map data reserve unit for holding map data; and
an ID originating device position register for, at the moment that the coordinate information on said map data is input while said ID information is being received, registering said ID information and said coordinate information correspondingly to each other into said installation position managing database.

2. A registering system of the ID originating device installation position information according to claim 1, wherein, in a case where, at the moment of registering the ID information and the coordinate information into the installation position managing database, said identical ID information has already been registered into said installation position managing database, the ID originating device position register updates said coordinate information of said ID information already registered, based upon coordinate information input newly by the position information input device.

3. A registering system of the ID originating device installation position information according to claim 1, wherein the position information input device:
provides a coordinate information input user interface screen for inputting the coordinate information of the installation position of the ID originating device to a terminal that a user who does a work of registering the installation position of the ID originating device has;
causes the terminal to display a screen including a reception ID display for displaying the ID information received by the ID receiver and a map display for displaying a map image of the location in which said ID originating device is installed as said coordinate information input user interface screen; and
inputs the installation position coordinates of said ID originating device as coordinate information on said map image, according to an operation of directly designating the position on the map image that is displayed on said map display as installation position coordinates of said ID originating device.

4. A registering system of the ID originating device installation position information according to claim 3, wherein the position information input device:
causes the terminal to display a screen including a reception ID display for displaying the ID information received by the ID receiver, a map display for displaying a map image of the location in which the ID originating device is installed, and a map selector for selecting the map image of the location in which said ID originating device is installed as a coordinate information input user interface screen; and
inputs the installation position coordinates of said ID originating device as coordinate information on the map image selected by said map selector.

5. A registering system of ID originating device installation position information for registering coordinate information of an installation position of an ID originating device and ID information being originated by said ID originating device correspondingly to each other into an installation position managing database, said registering system comprising:
an ID receiver for receiving the ID information being originated from said ID originating device;
a position information input device for inputting the coordinate information;
a map data reserve unit for holding a map data; and
an ID originating device position register for, at the moment that the coordinate information on said map data is input while said ID information is being received, registering said ID information and said coordinate information correspondingly to each other into said installation position managing database; and
an ID originating device installation position information acquire unit for acquiring the installation position information of said ID originating device already registered into said installation position managing database.

6. A registering system of the ID originating device installation position information according to claim 5, wherein, in a case where, at the moment of registering the ID information and the coordinate information into the installation position managing database, said identical ID information has already been registered into said installation position managing database, the ID originating device position register updates said coordinate information of the said ID information already registered, based upon coordinate information input newly by the position information input device.

7. A registering system of the ID originating device installation position information according to claim 5, wherein the position information input device:
provides a coordinate information input user interface screen for inputting the coordinate information of the installation position of the ID originating device to a terminal that a user who does a work of registering the installation position of the ID originating device has;
causes the terminal to display a screen including a reception ID display for displaying the ID information received by the ID receiver and a map display for displaying a map image of the location in which said ID originating device is installed as said coordinate information input user interface screen; and
inputs the installation position coordinates of said ID originating device as coordinate information on said map image, according to an operation of directly designating the position on the map image that is displayed on said map display as installation position coordinates of said ID originating device.

8. A registering system of the ID originating device installation position information according to claim 7, wherein the position information input device:
causes the terminal to display a screen including a reception ID display for displaying the ID information received by the ID receiver, a map display for displaying a map image of the location in which the ID originating device is installed, and a map selector for selecting the map image of the location in which said ID originating device is installed as a coordinate information input user interface screen; and
inputs the installation position coordinates of said ID originating device as coordinate information on the map image selected by said map selector.

9. A registering system of the ID originating device installation position information according to claim 7, wherein, in a case where, at the moment of displaying the map image on the map display of the coordinate information input user interface screen, the ID originating device already registered into the identical map image exists, the position information input device displays an ID originating device icon indicative of said ID originating device on the map image, based upon the coordinate information registered into the installation position managing database.

10. A registering system of the ID originating device installation position information according to claim 7, wherein the position information input device displays whether or not the ID originating device having the ID information received by the ID receiver has been registered into the installation position managing database on the reception ID display of the coordinate information input user interface screen.

11. A registering device of ID originating device installation position information for registering coordinate information of an installation position of an ID originating device and ID information being originated by said ID originating device correspondingly to each other into an installation position managing database, said registering device comprising:
an ID receiver for receiving the ID information being originated from said ID originating device;
a position information input device for inputting coordinate information;
a map data reserve unit for holding map data; and
an ID originating device position register for, at the moment that the coordinate information on said map data is input while said ID information is being received, registering said ID information and said coordinate information correspondingly to each other into said installation position managing database.

12. A registering device of ID originating device installation position information for registering coordinate information of an installation position of an ID originating device and ID information being originated by said ID originating device correspondingly to each other into an installation position managing database, said registering device comprising:
an ID receiver for receiving the ID information being originated from said ID originating device;
a position information input device for inputting coordinate information;
a map data reserve unit for holding map data;
an ID originating device position register for, at the moment that the coordinate information on said map data is input while said ID information is being received, registering said ID information and said coordinate information correspondingly to each other into said installation position managing database; and
an ID originating device installation position information acquire unit for acquiring the installation position information of said ID originating device already registered into said installation position managing database.

13. A registering method of ID originating device installation position information for registering coordinate information of an installation position of an ID originating device and ID information being originated by said ID originating device correspondingly to each other into an installation position managing database, said registering method comprising:
an ID receiving step of receiving the ID information being originated from said ID originating device;
a position information inputting step of inputting coordinate information; and
an ID originating device position registering step of, at the moment that the coordinate information on the map data being held by a map data reserve unit is input while said ID information is being received, registering said ID information and said coordinate information correspondingly to each other into said installation position managing database.

14. A registering method of the ID originating device installation position information according to claim 13, wherein, in the ID originating device position registering step, in a case where, at the moment of registering the ID information and the coordinate information into the installation position managing database, said identical ID information has already been registered into said installation position managing database, said coordinate information of said ID information already registered is updated, based upon coordinate information input newly in the position information inputting step.

15. A registering method of the ID originating device installation position information according to claim 13, wherein, in the position information inputting step:
a coordinate information input user interface screen for inputting the coordinate information of the installation position of the ID originating device is provided to a terminal that a user who does a work of registering the installation position of the ID originating device has;
the terminal is caused to display a screen including a reception ID display for displaying the ID information received in the ID receiving step and a map display for displaying a map image of the location in which said ID originating device is installed as said coordinate information input user interface screen; and
the installation position coordinates of said ID originating device are input as coordinate information on said map image, according to an operation of directly designating the position on the map image that is displayed on said map display as installation position coordinates of said ID originating device.

16. A registering method of the ID originating device installation position information according to claim 15, wherein, in the position information inputting step:
the terminal is caused to display a screen including a reception ID display for displaying the ID information received in the ID receiving step, a map display for displaying a map image of the location in which the ID originating device is installed, and a map selector for selecting the map image of the location in which said ID originating device is installed as a coordinate information input user interface screen; and
the installation position coordinates of said ID originating device are input as coordinate information on the map image selected by said map selector.

17. A registering method of ID originating device installation position information for registering coordinate information of an installation position of an ID originating device and ID information being originated by said ID originating device correspondingly to each other into an installation position managing database, said registering method comprising:
an ID receiving step of receiving the ID information being originated from said ID originating device;
a position information inputting step of inputting coordinate information;
an ID originating device position registering step of, at the moment that the coordinate information on map data being held by a map data reserve unit is input while said ID information is being received, registering said ID information and said coordinate information correspondingly to each other into said installation position managing database; and
an ID originating device installation position information acquiring step of acquiring the installation position information of said ID originating device already registered into said installation position managing database.

18. A registering method of ID originating device installation position information according to claim 17, wherein, in the ID originating device position registering step, in a case where, at the moment of registering the ID information and the coordinate information into the installation position managing database, said identical ID information has already been registered into said installation position managing database, said coordinate information of said ID information already registered is updated, based upon coordinate information input newly in the position information inputting step.

19. A registering method of the ID originating device installation position information according to claim 17, wherein, in the position information inputting step:
a coordinate information input user interface screen for inputting the coordinate information of the installation position of the ID originating device is provided to a terminal that a user who does a work of registering the installation position of the ID originating device has;
the terminal is caused to display a screen including a reception ID display for displaying the ID information received in the ID receiving step and a map display for displaying a map image of the location in which said ID originating device is installed as said coordinate information input user interface screen; and
the installation position coordinates of said ID originating device are input as coordinate information on said map image, according to an operation of directly designating the position on the map image that is displayed on said map display as installation position coordinates of said ID originating device.

20. A registering method of the ID originating device installation position information according to claim 19, wherein, in the position information inputting step:
the terminal is caused to display a screen including a reception ID display for displaying the ID information received in the ID receiving step, a map display for displaying a map image of the location in which the ID originating device is installed, and a map selector for. selecting the map image of the location in which said ID originating device is installed as a coordinate information input user interface screen; and
the installation position coordinates of said ID originating device are input as coordinate information on the map image selected by said map selector.

21. A registering method of the ID originating device installation position information according to claim 19, wherein, in the position information inputting step, in a case where, at the moment of displaying a map image on the map display of the coordinate information input user interface screen, the ID originating device already registered into the identical map image exists, an ID originating device icon indicative of said ID originating device is displayed on the map image based upon the coordinate information registered into the installation position managing database.

22. A registering method of the ID originating device installation position information according to claim 19, wherein, in the position information inputting step, it is displayed whether or not the ID originating device having the ID information received in the ID receiving step has been registered into the installation position managing database on the reception ID display of the coordinate information input user interface screen.

23. A registering program of ID originating device installation position information for registering coordinate information of an installation position of an ID originating device and ID information being originated by said ID originating device correspondingly to each other into an installation position managing database, said registering program causing a computer to execute:
an ID receiving process of receiving the ID information being originated from said ID originating device;
a position information inputting process of inputting coordinate information; and
an ID originating device position registering process of, at the moment that the coordinate information on the map data being held by a map data reserve unit is input while said ID information is being received, registering said ID information and said coordinate information correspondingly to each other into said installation position managing database.

24. A registering program of ID originating device installation position information for registering coordinate information of an installation position of an ID originating device and ID information being originated by said ID originating device correspondingly to each other into an installation position managing database, said registering program causing a computer to execute:
an ID receiving process of receiving the ID information being originated from said ID originating device;
a position information inputting process of inputting coordinate information;
an ID originating device position registering process of, at the moment that the coordinate information on a map data being held by a map data reserve unit is input while said ID information is being received, registering said ID information and said coordinate information correspondingly to each other into said installation position managing database; and
an ID originating device installation position information acquiring process of acquiring the installation position information of said ID originating device already registered into said installation position managing database.
